(19) United States
(12) Patent Application Publication
(10) Pub. No.: US 2015/0040956 A1
(43) Pub. Date: Feb. 12, 2015

(54) Crutch Accessory

(71) Applicant: Medline Industries, Inc., Mundelein, IL (US)

(72) Inventors: Michael Turturro, Chicago, IL (US); Edward Drower, Northbrook, IL (US)

(73) Assignee: Medline Industries, Inc., Mundelein, IL (US)

(21) Appl. No.: 13/961,683

(22) Filed: Aug. 7, 2013

(51) Int. Cl. A61H 3/02

(52) U.S. Cl. CPC A61H 3/02
USPC 135/66; 427/2.1

(57) ABSTRACT

A device includes a crutch (400) comprising at least two vertical crutch columns (404,405). A substantially flat panel (422) is attached to the crutch interior to the at least two vertical crutch columns. In one embodiment, the substantially flat panel comprising a marking receiving panel to accept a marking (530) from a marking instrument (531). The substantially flat panel can be at least partially coated with a marking receiving coating (302) in one embodiment.

### BACKGROUND

1. Technical Field

This disclosure relates generally to crutches, and more particularly to crutch accessories.

2. Background Art

Crutches have been used for centuries during rehabilitation of injuries to hips and legs. For example, when a leg is broken or an ankle is sprained, a person may use one or two crutches while the leg or ankle heals.

While crutches have been used for a long time, and while some of the materials used to make crutches have become stronger and lighter, the essential design, shape, and function of a crutch has not changed. A person uses a crutch to reduce the amount of weight loading an injured body portion. A person also uses a crutch to increase stability and balance when a lower limb or connecting part is injured or otherwise not available for mobility.

As the design of crutches has not varied for a long time, it would be advantageous to have an accessory to enhance the feature set of a crutch.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a crutch in accordance with one or more embodiments of the disclosure.

FIG. 2 illustrates an explanatory crutch accessory in accordance with one or more embodiments of the disclosure.

FIG. 3 illustrates a method of making a crutch accessory autographable in accordance with one or more embodiments of the disclosure.

FIG. 4 illustrates an explanatory crutch having a crutch accessory attached thereto in accordance with one or more embodiments of the disclosure.

FIG. 5 illustrates an explanatory method of using an autographable crutch accessory in accordance with one or more embodiments of the disclosure.

FIG. 6 illustrates another explanatory crutch in accordance with one or more embodiments of the disclosure.

FIG. 7 illustrates another explanatory crutch in accordance with one or more embodiments of the disclosure.

FIG. 8 illustrates various examples of autographable crutch accessories in accordance with one or more embodiments of the disclosure.

FIG. 9 illustrates another explanatory crutch having a crutch accessory attached thereto in accordance with one or more embodiments of the disclosure.

FIG. 10 illustrates another explanatory crutch having a crutch accessory attached thereto in accordance with one or more embodiments of the disclosure.

FIG. 11 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide an accessory for a crutch. In one embodiment, the accessory is autographable. In one embodiment, a substantially flat panel is attached to a crutch. In one embodiment, the substantially flat panel comprises a marking receiving panel to accept a marking from a marking instrument. As used herein, “marking receiving” means that the panel is configured to receive markings from a marking instrument where those markings dry quickly, are at least semi-permanent, and are not readily altered mechanically by, for example, smearing or smudging, unless otherwise designated in limited embodiments.

The panel can be a marking receiving panel in one of two ways. In a first embodiment, the marking receiving panel is manufactured from a marking receiving material. In another embodiment, the panel comprises a marking receiving coating. As used herein, a “marking receiving coating” is a special coating configured to receive markings from a marking instrument where those markings dry quickly, are at least semi-permanent, and are not readily altered mechanically by, for example, smearing or smudging, unless otherwise designated in limited embodiments.

In one embodiment, the substantially flat panel is attached within a frame defined by a crutch. For example, in one embodiment, the substantially flat panel is attached interior to at least two vertical crutch columns of a crutch. In one embodiment, the substantially flat panel is disposed interior to the at least two vertical crutch columns in at least two dimensions.

In one embodiment, the marking receiving coating at least partially covers the substantially flat panel. In one embodiment, the marking receiving coating covers the entire panel. In other embodiments, the marking receiving coating is selectively disposed along portions of the substantially flat panel to perform two functions: first, the marking receiving coating is to accept a marking from a marking instrument such as a pen, marker, or pencil. Second, either the shape of the panel or the selective application of the marking receiving coating can impart an aesthetically pleasing appearance to the panel and/or the crutch to which the panel is attached. In yet other embodiments, the marking receiving coating can be selectively disposed on the substantially flat panel so as to indicate, when the panel is attached within a frame of the crutch, that the panel is autographable.

Crutches having autographable panels configured in accordance with one or more embodiments of the disclosure provide numerous advantages over prior art crutch systems. A principle advantage is the providing the ability for a user of the crutch to receive autographs and get-well wishes from friends, family, and acquaintances. The disclosure contemplates that modern casts are fiberglass instead of plaster, and that fiberglass does not constitute a marking receiving material as markings from markers and ink pens applied to fiberglass are slow to dry, impermanent, and smudge and smear easily. At the same time, the inventors have determined that friends, family, and acquaintances still desire to provide well wishes to those suffering from injury or other conditions requiring the use of medical devices in the form of markings. Embodiments of the disclosure advantageously provide a device to receive markings and display them so that received autographs and get-well wishes can be displayed during recovery.

In one embodiment, to create the autographable panel, at least a portion of the panel is coated with a marking receiving coating. The color of the coating can vary. For example, it can be a clear coating in one embodiment. In another embodiment, it can be a white coating. In another embodiment, it can be a colored coating, such as grey, red, blue, yellow, or green. In one embodiment, the marking receiving coating comprises a colored pigment selected to render markings disposed thereon visible to an onlooker. Once the marking receiving coating is disposed on at least portions of the panel, markings from a marking instrument can be deposited on the marking receiving coating. In one or more embodiments, the material selected for the panel can be a marking receiving material, in which no coating is necessary.

Where used, the marking receiving material and/or coating can be adapted to a predetermined marking to be received. For example, in one embodiment, the marking instrument is a marker. The marker can be indelible or non-permanent. The marking receiving material and/or coating can be adapted so that marker markings dry quickly and do not smudge. Similarly, in another embodiment, the marking instrument is an ink pen. Ink pens may use different inks from markers. Accordingly, the marking receiving material and/or coating can be adapted so that ink pen markings dry quickly and do not smudge. In yet another embodiment, the marking instrument can be a pencil. The marking receiving material and/or coating can be adapted so that pencil markings are at least semi-permanent and do not smudge readily. In yet another embodiment, the marking instrument can be chalk. The marking receiving material and/or coating can be adapted so that chalk markings are retained on the coating and do not erase easily.

In yet other embodiments, the user of the autographable crutch may want to continually reconfigure the crutch. Accordingly, in one embodiment the marking instrument may be a dry erase marker. The marking receiving material and/or coating can be adapted so that markings are easily erasable by making the coating glossy.

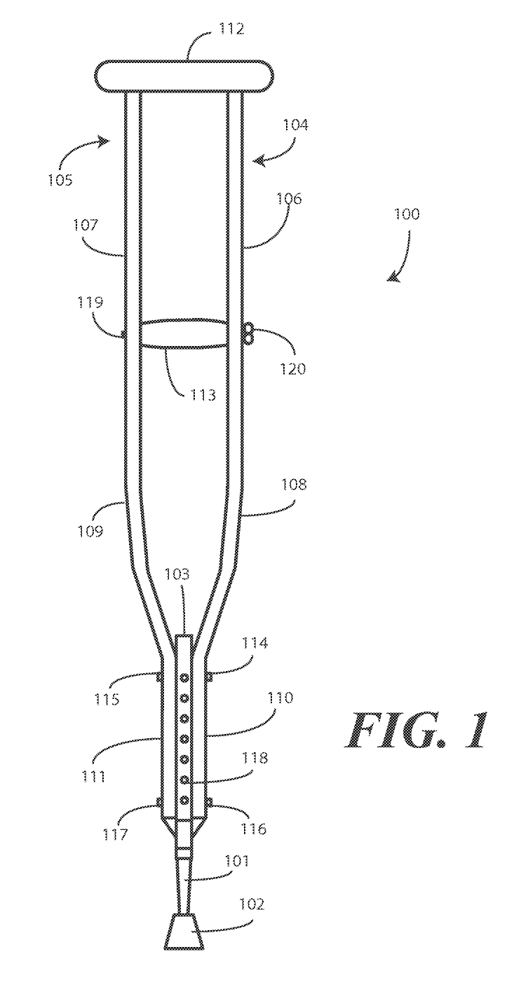

Turning now to FIG. 1, illustrated therein is a crutch 100 in accordance with one or more embodiments of the disclosure. The crutch 100 can be manufactured from metal, wood, fiberglass, carbon fiber, or other materials.

In one embodiment, the crutch 100 includes a substantially vertical, lower leg 101. The lower leg 101 can be covered with a slip-resistant tip 102 configured to increase a friction coefficient between the crutch 100 and a floor, street, or the ground.

An upper leg 103 extends from the lower leg 101. The upper leg 103 is disposed between lower portions of a pair of opposing vertical crutch columns 104,105. Each vertical crutch column 104,105 includes a plurality of sections. The sections include upper crutch sections 106,107, lower crutch sections 108,109, and leg coupling sections 110,111. In this illustrative embodiment, the lower crutch sections 108,109 are upwardly and outwardly inclined or curved as they extend from the leg coupling sections 110,111. The upper crutch sections 106,107 of this particular crutch 100 are substantially parallel, straight, and vertical.

The upper crutch sections 106,107 intersect a body-engaging beam 112 of the crutch 100. When the crutch 100 is in use, the body-engaging beam 112 is traditionally placed between the user's upper arm and torso beneath the armpit. The crutch 100 also includes a handgrip 113 that is disposed between the vertical crutch columns 104,105 between the upper crutch sections 106,107 and the lower crutch sections 108,109.

In FIG. 1, the vertical crutch columns 104,105 are coupled to the upper leg 103 at the leg coupling sections 110,111. The upper leg 103 can be adjustable within the leg coupling sections 110,111. In one embodiment, the upper leg 103 is releasable and movable within the leg coupling sections via bolts 114,116 or spring-loaded mechanical protrusions. In some embodiments the bolts 114,116 can be secured with wing nuts 115,117. Apertures 118 in the upper leg 103 allow the upper leg 103 to move vertically between the leg coupling sections 110,111 when the bolts 114,116 are removed. Locking the bolts 114,116 with the wing nuts 115,117 retains the upper leg 103 securely between the leg coupling sections 110,111.

As shown in FIG. 1, the handgrip 113 can be mounted between the vertical crutch columns 104,105 with a bolt 119 and wing nut 120 as well. As with the upper leg 103, the vertical crutch columns can include a plurality of apertures through which the bolt 119 can be placed to raise and lower the handgrip 113.

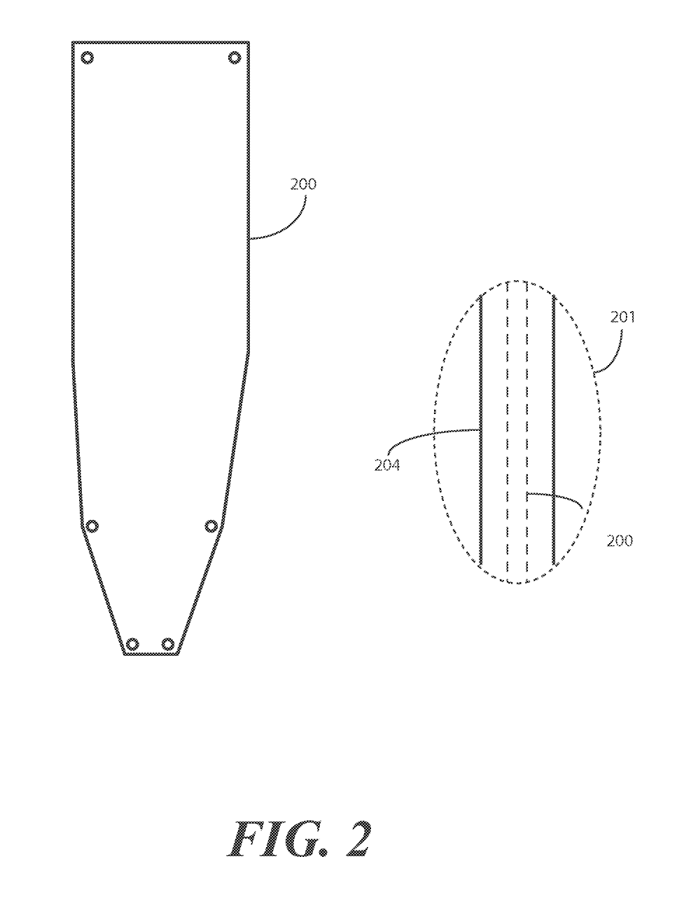

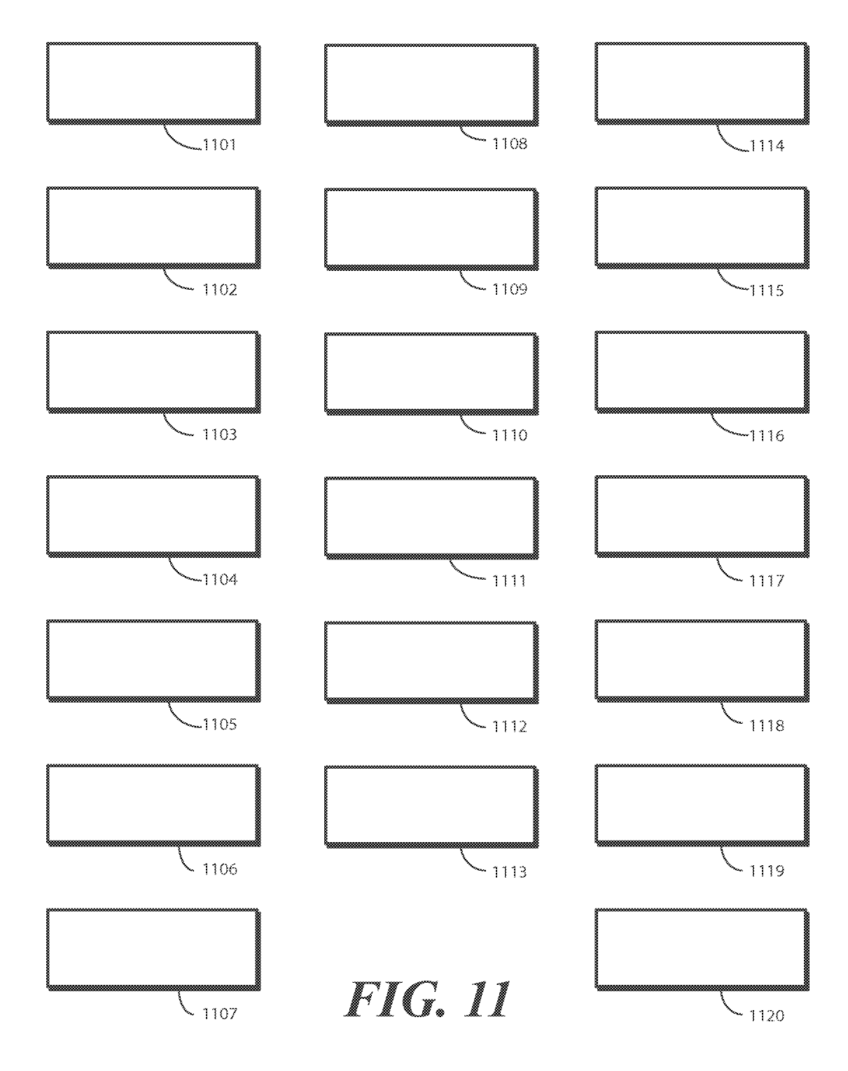

Turning now to FIG. 2, illustrated therein is a first example of a substantially flat panel 200 in accordance with one or more embodiments of the disclosure. The panel 200, in one embodiment, is thinner than is a vertical crutch column 204 of a crutch. Accordingly, when the panel 200 is attached to a crutch, and when the crutch is viewed from the side as shown in side view 201, the panel 200 will be hidden by the vertical crutch column 204. In the illustrative embodiment of FIG. 2, the panel includes a shape that will fit nicely and fill in the space between vertical crutch columns beneath the handgrip. As will be described with reference to FIG. 10 below, the panel 200 can take other decorative shapes as well.

In one embodiment, the panel 200 is manufactured from a marking receiving material. Illustrating by example, in one embodiment the panel 200 is made from wood. Lightweight woods, such as balsa wood, would be suitable for the panel in some embodiments. Wood, especially when unfinished, is a marking receiving material. In other embodiments, the panel 200 can be made from laminated or otherwise reinforced paper materials. Such materials also constitute marking receiving materials. The panel 200 could also be manufactured from metal. Some metals having matte finishes, including rolled aluminum, are suitable for receiving markings and thus can be marking receiving materials.

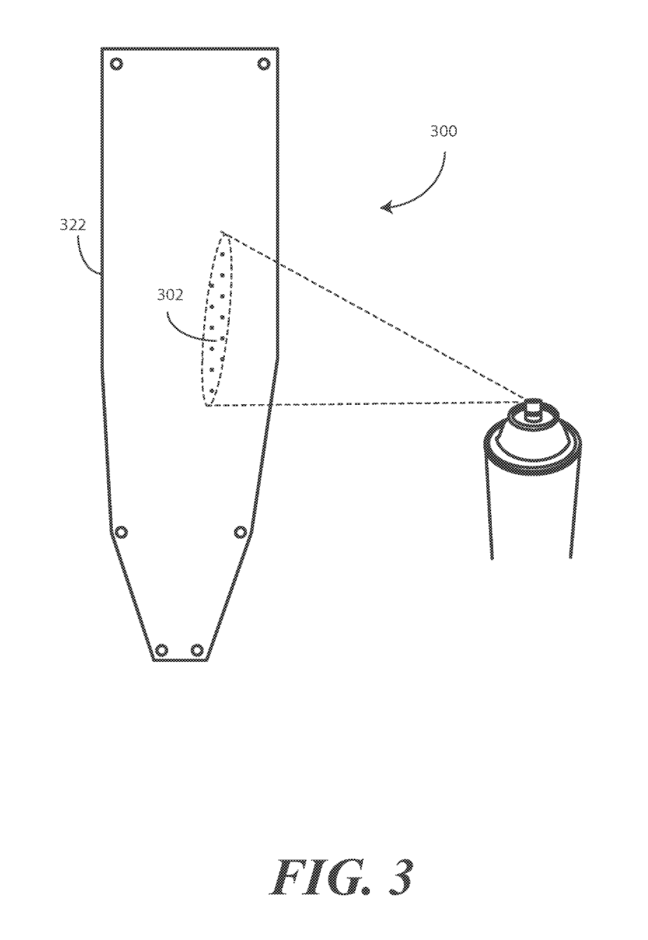

In other embodiments, yet another embodiment, where the substantially flat panel 322 is manufactured from a material that is not marking receiving, such as some metals, fiberglass, carbon fibers, some plastics, or other materials, the marking receiving coating 302 can be disposed on the material. As such, in other embodiments, the panel 200 will be coated with a marking receiving coating. A method of applying a marking receiving coating is shown in FIG. 3.

Turning now to FIG. 3, illustrated therein is one example of an autographable panel 300 configured in accordance with one or more embodiments of the disclosure. The autographable panel 300 is a device in accordance with the disclosure. For illustration purposes, the autographable panel 300 is shown as comprising a substantially flat panel 322 having a thickness of less than 0.25 inches (the thickness dimension is into the page in FIG. 3).

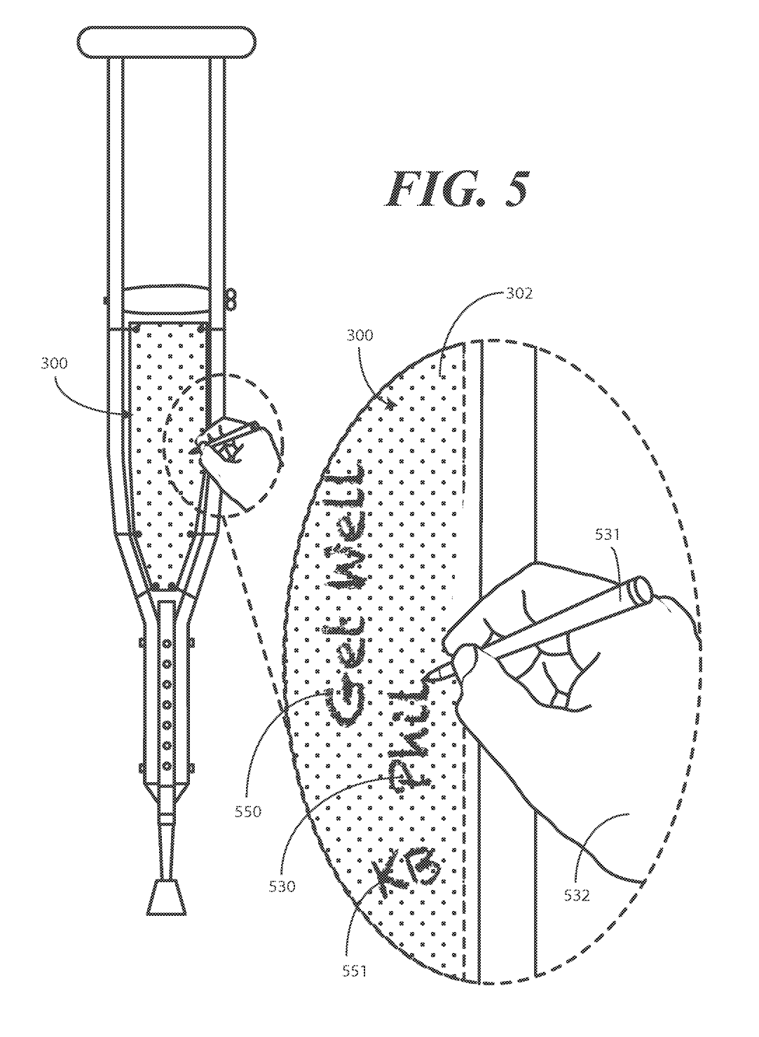

As shown, a marking receiving coating 302 is applied to at least partially cover the substantially flat panel 322. In one embodiment, the marking receiving coating 302 is to accept and/or receive a marking from a marking instrument as will be described below with reference to FIG. 5. The marking receiving coating 302 can take a variety of forms, a few embodiments of which will be set forth for illustrative purposes. In one embodiment, the marking receiving coating 302 comprises paint. For example, the paint in one embodiment can be an epoxy-based paint. In one embodiment, the paint comprises an epoxy-based enamel, such as an epoxy acrylic enamel. In other embodiments, the paint comprises an alkyd enamel, acrylic enamel, or other type of paint. Epoxy based paints are coatings that include chemical resins that, when reacted with oxygen form a hard, abrasion resistant, chemical, and solvent resistant coating. It will be clear to those of ordinary skill in the art having the benefit of this disclosure that other coatings can be used as the marking receiving coating 302 as well. For example, urethanes, oil-based coatings, latex coatings, polyester coatings, polyamide coatings, and other coatings can be used in some embodiments.

In one embodiment, the marking receiving coating 302 comprises a matte finish. Other embodiments, such as the dry erase marker scenario described above, may employ a glossy, shiny, or smooth coating. However, in many embodiments, a matte finish is well suited to receiving markings from marking instruments and allowing those markings to dry quickly, be permanently or semi-permanently retained, and resist smearing or smudging.

As noted above, the marking receiving coating 302 can comprise various colors. For example, it can be a clear coating in one embodiment. In another embodiment, it can be a white coating. In another embodiment, it can be a colored coating, such as grey, red, blue, yellow, or green. In one embodiment, the marking receiving coating 302 comprises a colored pigment selected to render markings disposed thereon visible to an onlooker. Once the marking receiving coating 302 is disposed on at least portions of the crutch, markings from a marking instrument can be deposited on the marking receiving coating.

The marking receiving coating 302 applied can be adapted to a predetermined marking to be received. Additionally, the marking receiving coating 302 can be to receive a marking without smearing. For example, in one embodiment, the marking instrument is a marker. The marker can be indelible or non-permanent. The marking receiving coating 302 can be adapted so that marker markings dry quickly and do not smudge. Similarly, in another embodiment, the marking instrument is an ink pen. Ink pens may use different inks from markers. Accordingly, the marking receiving coating 302 can be adapted so that ink pen markings dry quickly and do not smudge. In yet another embodiment, the marking instrument can be a pencil. The marking receiving coating 302 can be adapted so that pencil markings are at least semi-permanent and do not smudge readily. In yet another embodiment, the marking instrument can be chalk. The marking receiving coating 302 can be adapted so that chalk markings are retained on the coating and do not erase easily.

The marking receiving coating 302 can be deposited on various portions, or alternatively the entirety, of the substantially flat panel 322. For example, in one embodiment, the marking receiving coating 302 is disposed only on portions of the substantially flat panel 322. In another embodiment, the marking receiving coating 302 is disposed on an entirety of the substantially flat panel. In another embodiment, the marking receiving coating 302 is disposed on only one side of the substantially flat panel 322. In another embodiment, the marking receiving coating 302 is disposed on both sides of the substantially flat panel 322. Of course, combinations of these can be used. For example, in one embodiment the marking receiving coating 302 is disposed on an entirety of one side of the substantially flat panel 322, but only on portions of the other side.

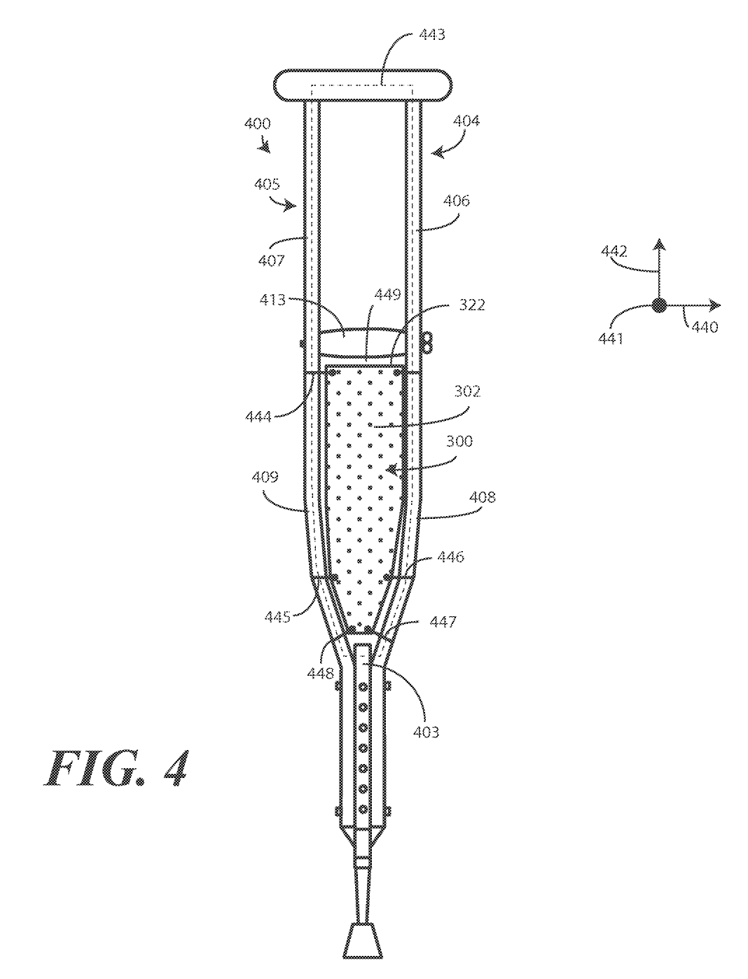

Turning now to FIG. 4, illustrated therein is an example of a crutch 400 equipped with an autographable panel 300 in accordance with one or more embodiments of the disclosure.

As shown in FIG. 3, the crutch 400 includes at least two vertical crutch columns 404,405. A substantially flat panel 322 has been attached to the crutch 400 interior to the at least two vertical columns 404,405. In this embodiment, the substantially flat panel 322 is thinner (dimension 441 into the page) than are the vertical columns 404,405, so the substantially flat panel 322 is attached to the crutch 400 interior to the at least two vertical columns 404,405 in at least two dimensions 440,441. Since the substantially flat panel 322 is bounded by the handgrip 413 and the upper leg 403, the substantially flat panel 322 is actually attached to the crutch 400 interior to a frame 443 defined by the crutch in three dimensions 440,441,442.

The substantially flat panel 322 can be attached to the vertical columns 404,405 in a variety of ways. One or more mechanical fasteners can be used to attach the substantially flat panel 322 to the vertical columns 404,405 in one or more embodiments. For example, in one embodiment, mechanical clips 444,445 can be used as fasteners to attach the substantially flat panel 322 to the vertical columns 404,405. In another embodiment, zip ties 446 can be used as fasteners to attach the substantially flat panel 322 to the vertical columns 404,405. In another embodiment, hook and loop fasteners 447 can be used to attach the substantially flat panel 322 to the vertical columns 404,405. In another embodiment, bungee cords 448 can be used as fasteners to attach the substantially flat panel 322 to the vertical columns 404,405. The fasteners have been illustrated in combination in FIG. 4 for convenience. However, generally speaking the fastener type used will be uniform. Additionally, other attachment mechanisms will be obvious to those of ordinary skill in the art having the benefit of this disclosure. For example, magnetic or spring-loaded devices can be used to attach the substantially flat panel 322 to the vertical columns 404,405.

In this embodiment, to transform the substantially flat panel 322 into an autographable panel 300, a coating 302 has been applied to at least a portion of a substantially flat panel. In this embodiment, the coating 302 has been applied to all planar portions of the substantially flat panel 322. In this embodiment, the coating 302 comprises a coating to receive a marking from a marking instrument.

In the illustrative embodiment of FIG. 4, the autographable panel 300 has been attached to the vertical columns 404,405 at the lower crutch sections 408,409, leaving sufficient space 449 between the handgrip 413 and the top of the autographable panel 300 to accommodate a user's hand. In other embodiments, the autographable panel 300 can be attached to the upper crutch sections 406,407. However, in many applications it is advantageous to couple the autographable panel 300 to the lower crutch sections 408,409 so as not to interfere with a user's elbow or torso, which may sometimes enter the space interior to the upper crutch sections 406,407 when the crutch 400 is in use.

Turning now to FIG. 5, illustrated therein is a method for using the autographable panel 300. A person 532 is marking the coating 302 with a marking 530. In this illustrative embodiment, the marking 530 is an autograph. Accordingly, the person 532 is marking the coating 302 by autographing the autographable panel 300. It should be understood that the marking 530 can take other forms, including get-well messages 550. Where that is the case, the person 532 may mark the coating by applying the get-well message 550 to the coating 302 of the autographable panel 300 by applying a get-well message 550 to the coating 302. Other types of markings 530 will be obvious to those of ordinary skill in the art having the benefit of this disclosure. For example, the marking 530 could alternatively be an advertisement, a design 551, a picture, a logo, a representing a favorite hobby or sporting team.

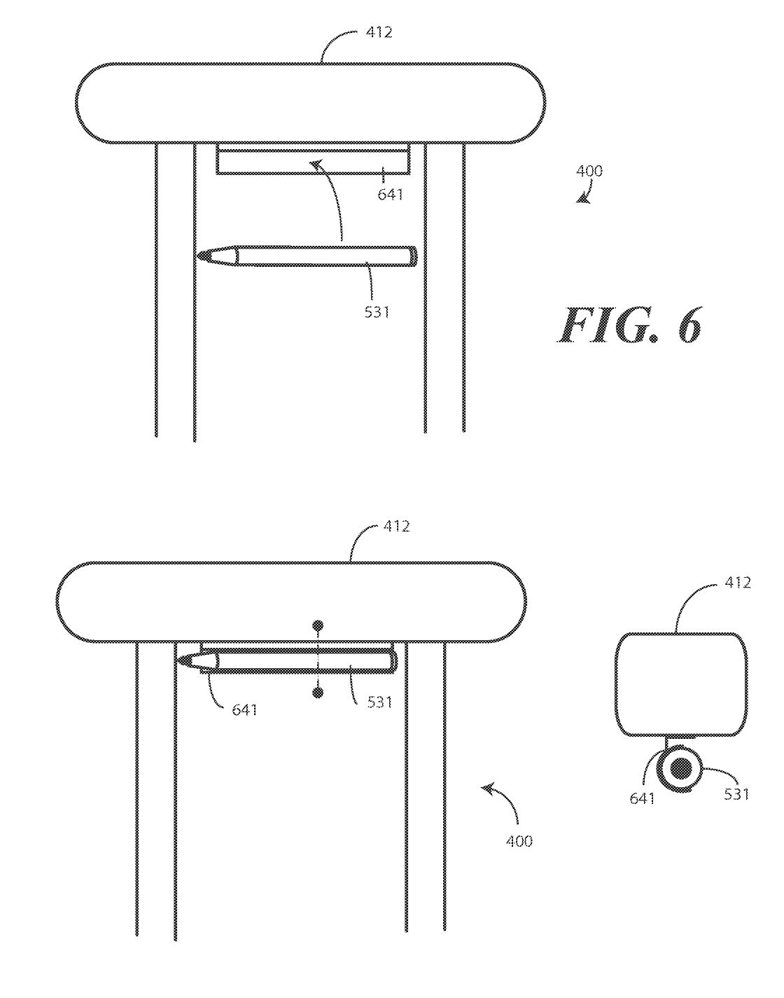

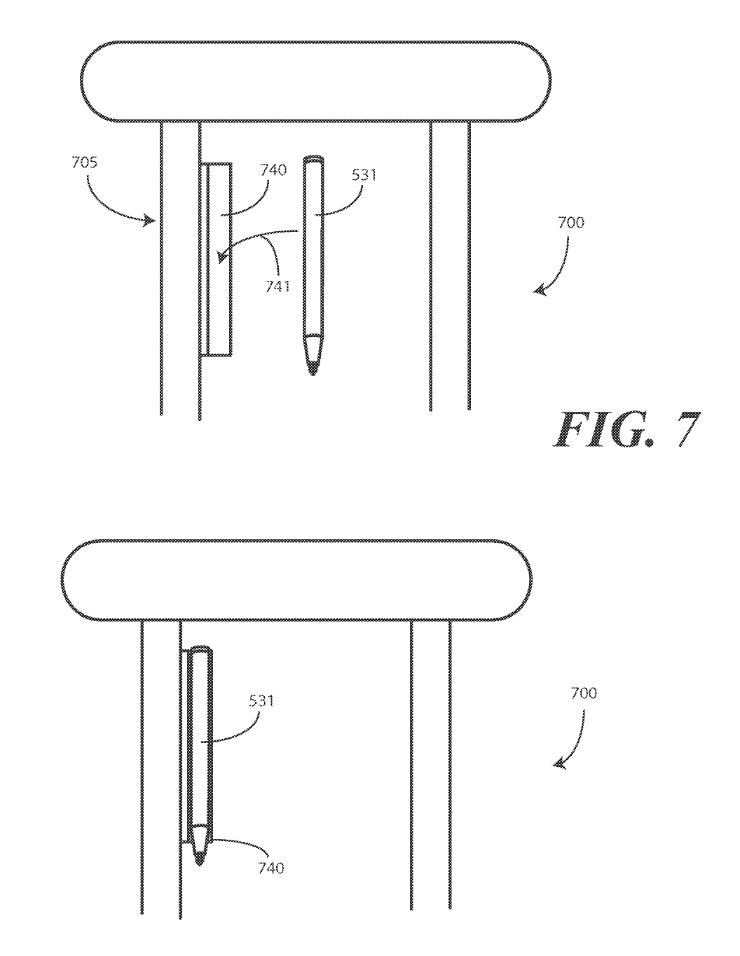

As noted previously, the coating 302 can be adapted to receive markings from a particular marking instrument 531. Manufacturers may desire to pair specific marking instruments with particular coatings. In other applications, the user of the autographable panel 300 may want to have a pen, pencil, marker, or other marking instrument handy at all times. To accommodate either scenario, in one embodiment the crutch 400 can be configured with a holder for the marking instrument. Examples of such an embodiment are shown in FIGS. 6 and 7.

Beginning with FIG. 6, a crutch 400 comprises a holder 640 to receive 641 a marking instrument 531. In one embodiment, the marking instrument 531 comprises a marker. In another embodiment, the marking instrument 531 comprises a pencil. In another embodiment, the marking instrument 531 comprises an ink pen. In another embodiment, the marking instrument 531 comprises chalk. In another embodiment, the marking instrument 531 comprises a dry erase marker.

In this illustrative embodiment, the holder 640 comprises a C-shaped clip that receives 641 the marking instrument 531. The C-shape expands with the marking instrument 531 is inserted, and then clasps the marking instrument 531 within the C-shape. In one embodiment, the holder 640 is manufactured from a pliable plastic material. In another embodiment, the holder 640 is manufactured from a springy metal material.

In the illustrative embodiment of FIG. 6, the holder 640 is coupled to the body-engaging beam 612 of the crutch 400. In one embodiment, the holder 640 is adhesively attached to the body-engaging beam 612. In another embodiment, the holder 640 is bonded to the body-engaging beam 612 of the crutch 400. In another embodiment, the holder 640 is screwed or bolted to the body-engaging beam 412 of the crutch 400. Other connection or coupling techniques will be obvious to those of ordinary skill in the art having the benefit of this disclosure.

Turning to FIG. 7, a crutch 700 comprises another holder 740 to receive 741 a marking instrument 531. In this illustrative embodiment, the holder 740 comprises a magnetic clip that receives 741 the marking instrument 531.

In the illustrative embodiment of FIG. 7, the holder 740 is coupled to the vertical crutch column 705 of the crutch 700. In one embodiment, the holder 740 is adhesively attached to the vertical crutch column 705. In another embodiment, the holder 740 is magnetically coupled to the vertical crutch column 705. In another embodiment, the holder 740 is bonded to the vertical crutch column 705. In another embodiment, the holder 740 is screwed or bolted to the vertical crutch column 705. Other connection or coupling techniques will be obvious to those of ordinary skill in the art having the benefit of this disclosure. Additionally, while the body-engaging beam (412) and the vertical crutch column 705 are two convenient places to attach a holder 740, other portions of the crutch 700 will be obvious to those of ordinary skill in the art having the benefit of this disclosure.

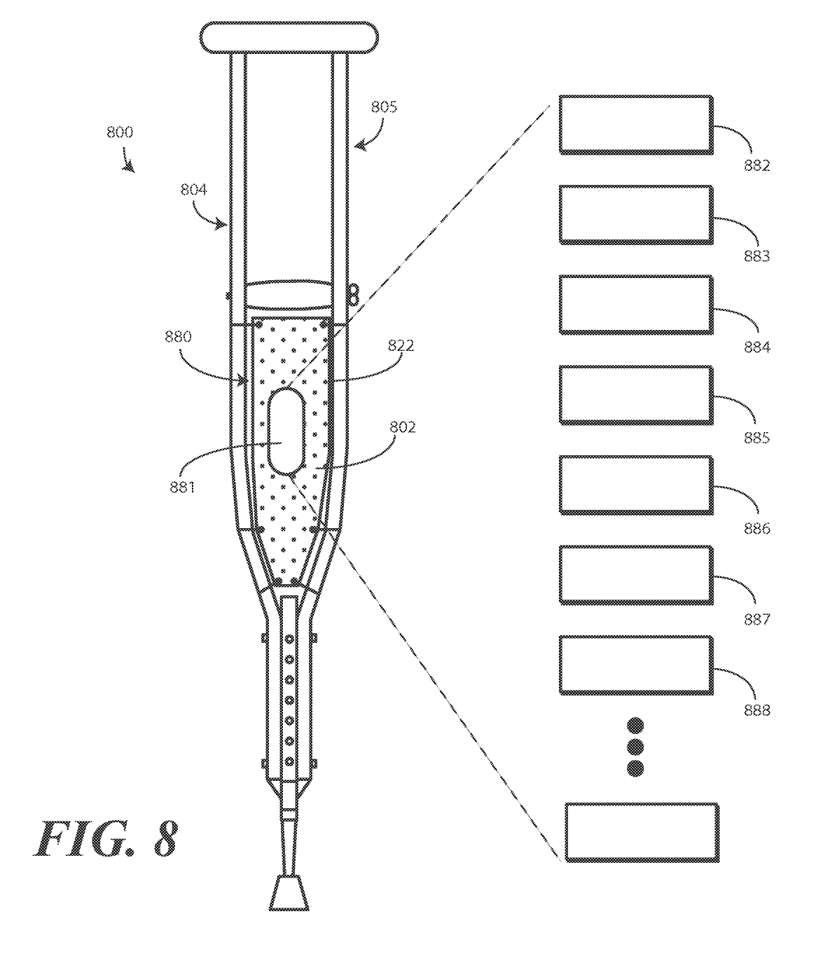

Turning now to FIG. 8, illustrated therein is another crutch 800 configured in accordance with one or more embodiments of the disclosure. The crutch 800 equipped with an autographable panel 880 in accordance with one or more embodiments of the disclosure.

As shown in FIG. 8, the crutch 800 includes at least two vertical crutch columns 804,405. A substantially flat panel 822 has been attached to the crutch 800 interior to the at least two vertical crutch columns 804,805. In this embodiment, to transform the substantially flat panel 822 into an autographable panel 880, a coating 802 has been applied to at least a portion of a substantially flat panel 822. In this embodiment, the coating 802 has been applied to all planar portions of the substantially flat panel 822. In this embodiment, the coating 802 comprises a coating to receive a marking from a marking instrument.

In the illustrative embodiment of FIG. 8, an accessory 881 is attached to the substantially flat panel 822. Any of a number of accessories can be attached to the substantially flat panel 822 to increase the feature set offered by the autographable panel 880. For example, in one embodiment the accessory 881 comprises a decal 882. Decals 882 can be attached by the user to customize the autographable panel 880. Alternatively, the decal 882 can identify the manufacturer of the autographable panel 880. In other embodiments, the decal 882 can include, for example, logos, pictures and slogans from sports teams. The decal 882 can provide advertisements for products, television shows, and movies. The decal 882 can be personalized with aesthetically pleasing designs or personal pictures.

In another embodiment, the accessory 881 comprises a bag 883. The user can place items that are frequently used within the bag 883 for easy carrying. In another embodiment, the accessory 881 can comprise a pad of paper 884. The user can write notes or other items on the pad of paper 884. In another embodiment, the accessory 881 comprises a cell phone holder 885. The user can attach a cell phone to the cell phone holder 885 for easy carrying. In another embodiment, the accessory 881 comprises a holder 886 for a writing instrument. In another embodiment, the accessory 881 comprises a pouch 887. The user can place items in the pouch 887 for convenient carry and accessibility. In another embodiment, the accessory 881 can comprise bling 888. Bling 888 can comprise decorative items such as rhinestones or glitter or “bedazzles.” Of course, combinations of accessories can be attached to the autographable panel 880. Additionally, those of ordinary skill in the art having the benefit of this disclosure will find obvious other types of accessories suitable for attachment to the autographable panel 880.

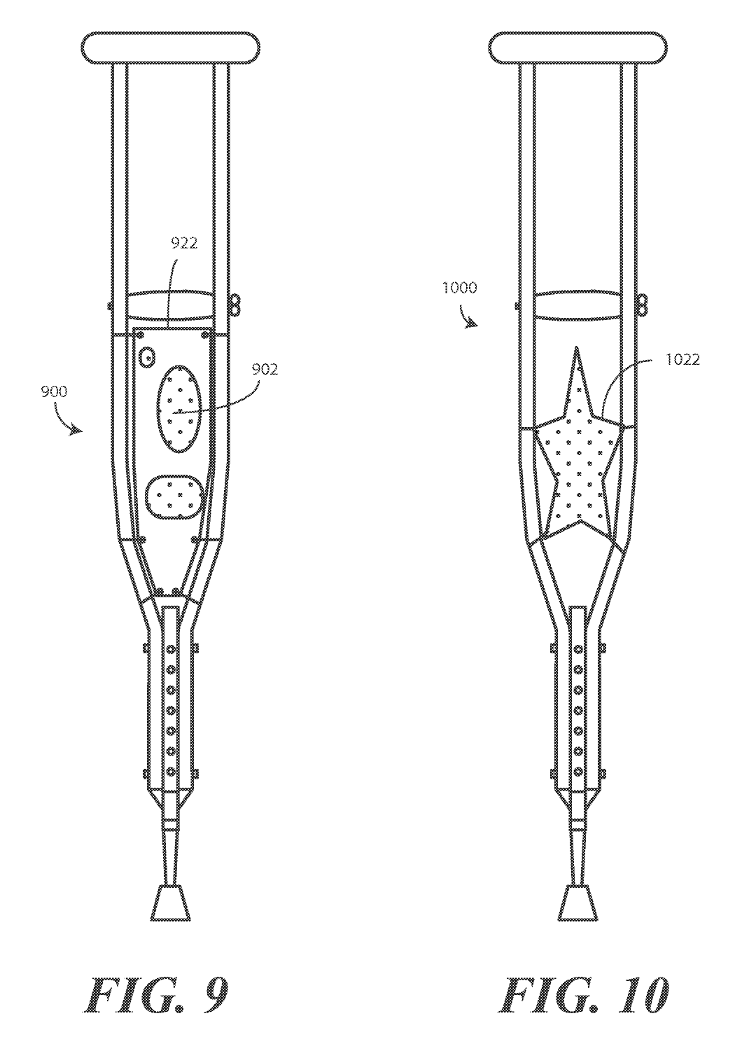

Turning now to FIG. 9, illustrated therein is another crutch 900 in accordance with one or more embodiments of the disclosure. In this embodiment, a marking receiving coating 902 has been selectively applied only to portions of the substantially flat panel 922. The locations at which the marking receiving coating 902 is disposed can vary based upon application or desire. For example, the selective locations can define a fashion statement, unique design, artistic design, or provide an aesthetically pleasing appearance in one embodiment. In other embodiments, the selective locations can provide a visible indication that the substantially flat panel is, in fact, an autographable panel. Accordingly, people seeing the visible indication will be alerted to the fact that they may autograph, mark, or otherwise place a marking on the selective locations of the autographable panel.

Turning now to FIG. 10, illustrated therein is yet another crutch 1000 configured in accordance with one or more embodiments of the disclosure. In the embodiment of FIG. 10, the substantially flat panel 1022 has been cut into a predefined shape. The predefined shape of this embodiment is a star. In one or more embodiments, the predefined shape is indicative of a holiday, such as Halloween, Thanksgiving, or Christmas. For example the star can be indicative of the Christmas holiday. In other embodiments, the predefined shape is indicative of a hobby. For example, the star could be indicative of camping. In other embodiments, the predefined shape is indicative of an object of admiration. Examples of objects of admiration include sporting teams, celebrities, fashion designs, cars, houses, and the like. Accordingly, the predefined shape could be a football helmet or baseball that is indicative of a particular sporting team. Other predefined shapes will be obvious to those of ordinary skill in the art having the benefit of this disclosure.

Turning now to FIG. 11, illustrated therein are various embodiments of the disclosure. At 1101, a device comprises a crutch comprising at least two vertical crutch columns. At 1101, a substantially flat panel is attached to the crutch interior to the at least two vertical crutch columns. At 1101, the substantially flat panel comprising a marking receiving panel to accept a marking from a marking instrument.

At 1102, the substantially flat panel of 1101 is attached to the crutch interior to the at least two vertical crutch columns in at least two dimensions. At 1103, the device of 1101 further comprises one or more fasteners to attach the substantially flat panel to the at least two vertical crutch columns.

At 1104, the device of 1101 further comprises a marking receiving coating at least partially covering the substantially flat panel. At 1104, the marking receiving coating is to accept the marking from the marking instrument.

At 1105, the marking receiving coating of 1104 comprises paint. At 1106, the paint of 1105 comprises epoxy. At 1107, the paint of 1105 is white.

At 1108, the marking receiving coating. The device of claim 1, the marking receiving coating disposed on an entirety of the substantially flat panel.

At 1109, the marking receiving coating of 1104 is selectively disposed on the substantially flat panel. At 1110, the marking instrument of 1101 comprises one of an ink pen or a marker. At 1111, the marking receiving coating of 1104 is to receive the marking without smearing.

At 1112, the device of 1101 further comprises a holder for the marking instrument. At 1113, the holder of 1112 is coupled to a body-engaging beam of the crutch. At 1114, the holder of 1112 is coupled to a vertical crutch column of the crutch.

At 1115, the device of 1101 further comprises an accessory attached to the substantially flat panel. At 1116, the accessory of 1115 comprises one or more of a decal, a bag, a pouch, a pad of paper, a cell phone holder, or a holder for the marking instrument.

At 1117, a method of using an autographable panel comprises marking a coating at least partially covering a substantially flat panel disposed within a frame defined by a crutch with a marking instrument. At 1118, the marking of 1117 comprises an autograph. At 1119, the marking of 1117 comprises applying a get-well message to the coating of the crutch.

At 1120, a method of manufacturing an autographable panel comprises applying a coating to at least a portion of a substantially flat panel. At 1120, the coating is to receive a marking from a marking instrument. At 1120, the applying transforms the substantially flat panel to an autographable panel. At 1120, the autographable panel is attached within a frame of a crutch.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A device, comprising:
a crutch comprising at least two vertical crutch columns; and
a substantially flat panel attached to the crutch interior to the at least two vertical crutch columns;
the substantially flat panel comprising a marking receiving panel to accept a marking from a marking instrument.

2. The device of claim 1, the substantially flat panel attached to the crutch interior to the at least two vertical crutch columns in at least two dimensions.

3. The device of claim 1, further comprising one or more fasteners to attach the substantially flat panel to the at least two vertical crutch columns.

4. The device of claim 1, further comprising a marking receiving coating at least partially covering the substantially flat panel, the marking receiving coating to accept the marking from the marking instrument.

5. The device of claim 4, the marking receiving coating comprising paint.

6. The device of claim 5, the paint comprising epoxy.

7. The device of claim 5, the paint white.

8. The device of claim 4, the marking receiving coating disposed on an entirety of the substantially flat panel.

9. The device of claim 4, the marking receiving covering selectively disposed on the substantially flat panel.

10. The device of claim 4, the marking instrument comprising one of an ink pen or a marker.

11. The device of claim 4, the marking receiving coating to receive the marking without smearing.

12. The device of claim 1, further comprising a holder for the marking instrument.

13. The device of claim 12, the holder coupled to a body-engaging beam of the crutch.

14. The device of claim 12, the holder coupled to a vertical crutch column of the crutch.

15. The device of claim 1, further comprising an accessory attached to the substantially flat panel.

16. The device of claim 15, the accessory comprising one or more of a decal, a bag, a pouch, a pad of paper, a cell phone holder, or a holder for the marking instrument.

17. A method, comprising:
marking a coating at least partially covering a substantially flat panel disposed within a frame defined by a crutch with a marking instrument.

18. The method of claim 17, the marking comprising an autograph.

19. The method of claim 17, the marking comprising applying a get-well message to the coating of the crutch.

20. A method, comprising:
applying a coating to at least a portion of a substantially flat panel, the coating to receive a marking from a marking instrument, the applying transforming the substantially flat panel to an autographable panel; and
attaching the autographable panel within a frame of a crutch.
